(19) United States
(12) Patent Application Publication
(10) Pub. No.: US 2007/0101116 A1
(43) Pub. Date: May 3, 2007

(54) Information processing apparatus with boot devices, and method for starting up the information processing apparatus

(76) Inventor: Tadashi Tsuji, Ome-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/589,674

(22) Filed: Oct. 30, 2006

(30) Foreign Application Priority Data
Oct. 31, 2005 (JP) 2005-317600

(51) Int. Cl. G06F 15/177

(52) U.S. Cl. 713/1

(57) ABSTRACT

According to one embodiment, a non-boot device initialization module initializes a plurality of non-boot devices necessary to boot an operating system upon power on of a computer. After initialization by the non-boot device initialization module, a boot device detection module detects, in a plurality of boot devices, a boot device which satisfies a condition for booting the operating system. A boot device initialization module included in the module sequentially initializes the boot devices one by one until the boot device which satisfies the condition is detected.

### CROSS-REFERENCE TO RELATED APPLICATIONS

This application is based upon and claims the benefit of priority from Japanese Patent Application No. 2005-317600, filed Oct. 31, 2005, the entire contents of which are incorporated herein by reference.

### BACKGROUND

1. Field

One embodiment of the invention relates to an information processing apparatus, such as a personal computer, and more particularly to an information processing apparatus with a plurality of boot devices, and a method for starting up the apparatus.

2. Description of the Related Art

In general, when an information processing apparatus, such as a personal computer, is turned on, a process for starting up the apparatus is performed. This process (start process) is called a power-on self-test (POST) and is performed by the Basic Input-Output System (BIOS). At the beginning of the start process, an initialization process is performed before booting (starting up) the operating system.

Information processing apparatuses are required to have various functions. For instance, they are required to be started up (booted) from a boot-enabled device (boot devices), such as a hard disk drive (HDD), an optical disk drive, local area network (LAN) controller, etc.

Accordingly, in the initialization process performed upon power-on of the information processing apparatus, all boot devices are initialized, as well as non-boot devices needed for booting the operating system, such as various buses, chipsets, memories, the keyboard controller (KBC) and graphics controller. Further, in the initialization process, assignment of resources to each boot device, and setting of interrupts, etc., are performed. After completing the initialization of all boot devices, the boot device that can boot the operating system is determined based on the priority of the boot devices arbitrarily set by a user.

By virtue of the above initialization process, the operating system can be booted not only from the hard disk drive, but also from a boot device, such as an optical disk drive, LAN controller or a machine (e.g., a server) connected to the LAN controller via a network, thereby starting up the information processing apparatus.

On the other hand, Jpn. Pat. Appln. KOKAI Publication No. 2000-298579 (hereinafter referred to as “the prior art document”), for example, discloses a technique for setting, when pressing of a particular key on a keyboard is detected during the startup of an information processing system, a setup setting pattern corresponding to the detected particular key. In this technique, the initialization process for starting up a BIOS setup menu is minimized by setting the setup setting pattern, thereby quickly starting up the setup menu. This initialization process is also executed in information processing apparatuses compliant with a multi-operating system including a plurality of operating systems.

As described above, in conventional information processing apparatuses such as personal computers, in the initialization process executed at the beginning of the start process performed by the BIOS, the initialization process of all boot devices and the setting process, such as assignment of resources to the boot device, are all performed. After all these processes are performed, i.e., after all preparations for booting (starting up) the operating system are completed, the operating system is booted. This being so, in the prior art, much time is required for the startup operation of the BIOS. Further, in the conventional information processing apparatuses compliant with the multi-operating system (multi OS), even the boot devices that are not used by the operating system are initialized. This may increase the power consumption.

The above-described prior art document also discloses a technique for minimizing the initialization process necessary to start up the BIOS setup menu. However, in the prior art document, it is not considered to minimize the initialization process necessary to boot the operating system. Further, in the prior art document, the setup setting pattern to designate the necessary initialization process is designated by pressing a particular key on the keyboard. Accordingly, it is necessary for a user to understand the relationship between the particular keys and the setup setting patterns.

### BRIEF DESCRIPTION OF THE SEVERAL VIEWS OF THE DRAWINGS

A general architecture that implements various features of the invention will now be described with reference to the drawings. The drawings and their associated descriptions are provided to illustrate the embodiments of the invention and not to limit the scope of the invention.

FIG. 1 is a perspective view illustrating an exemplary external appearance of a personal computer according to an embodiment of the invention;

FIG. 2 is a block diagram illustrating an exemplary system configuration of the personal computer of FIG. 1;

FIG. 3 is a view illustrating the essential configuration of the BIOS stored in the BIOS-ROM shown in FIG. 2;

FIG. 4 is a flowchart illustrating an exemplary procedure of a startup process employed in the embodiment; and

FIG. 5 is a flowchart illustrating an exemplary procedure of the boot device detection process shown in FIG. 4.

### DETAILED DESCRIPTION

Various embodiments according to the invention will be described hereinafter with reference to the accompanying drawings. In general, according to an embodiment of the invention, there is provided an information processing apparatus. The information processing apparatus comprises: a main body including a plurality of boot devices and a plurality of non-boot devices, the non-boot devices being necessary to boot an operating system; means for initializing the non-boot devices upon power on of the main body; means for detecting, in the boot devices, a boot device which satisfies a condition for booting the operating system, after initializing the non-boot devices, the detecting means including means for sequentially initializing the boot devices one by one until the boot device which satisfies the condition is detected; and means for booting the operating system from the boot device detected by the detecting means.

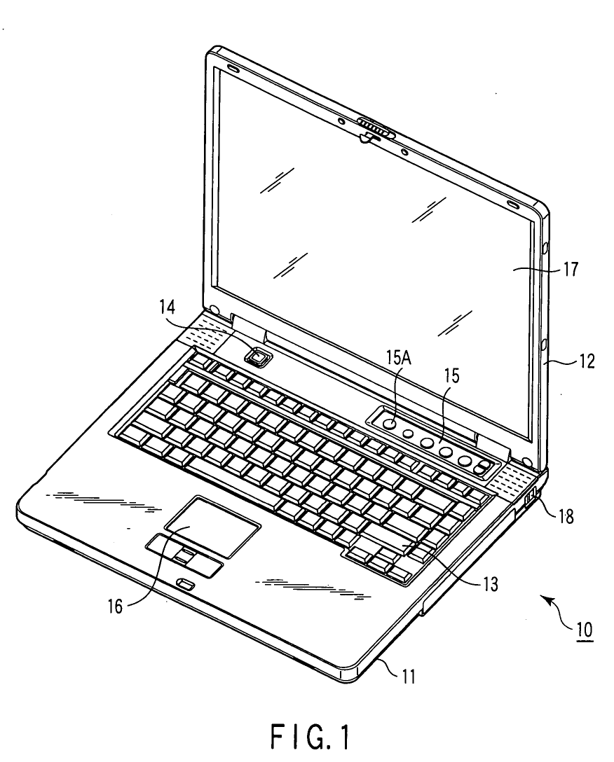

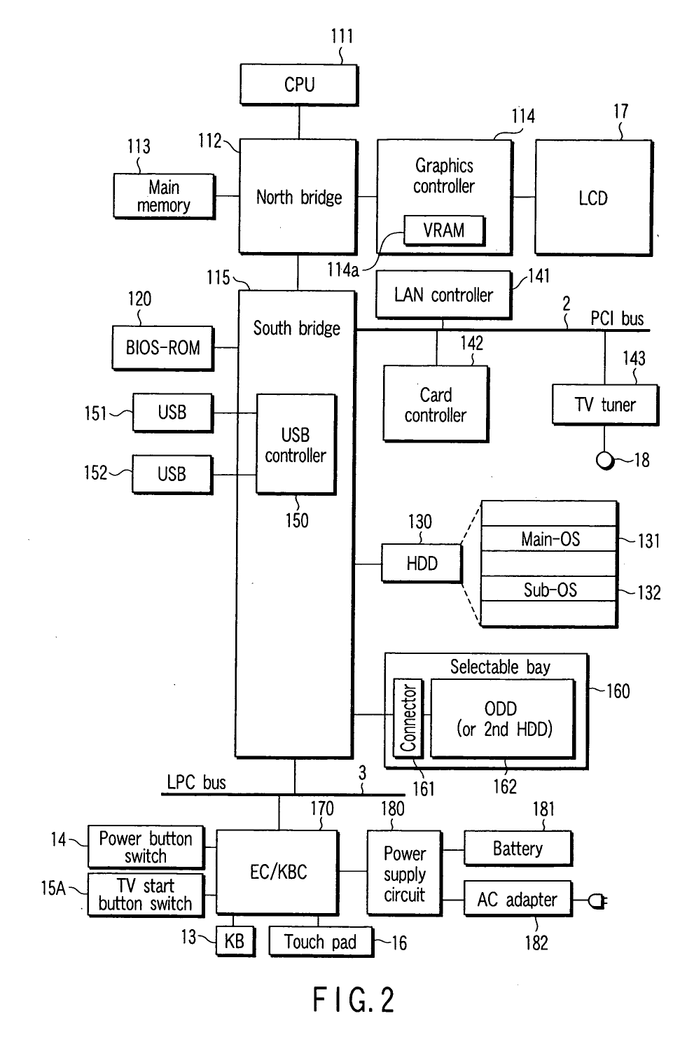

An embodiment of the invention will be described with reference to the accompanying drawings. Referring first to FIGS. 1 and 2, the configuration of an information processing apparatus according to the embodiment will be described. The information processing apparatus is implemented as, for example, a notebook personal computer 10.

FIG. 1 is a perspective view of the notebook personal computer 10 whose display unit is open. The computer 10 includes a main body 11 and a display unit 12. The display unit 12 incorporates a display device that is composed of a liquid crystal display (LCD) 17. The display screen of the LCD 17 is located in almost the central part of the display unit 12.

The display unit 12 is attached to the main body 11 so that it can pivot between an open position and a closed position. The main body 11 has a thin box-shaped case.

A keyboard 13, a power button switch (first switch) 14, an input operation panel 15 and a touch pad 16 are arranged on the top surface of the main body 11. The power button switch 14 is used to power on/power off the computer 10.

The input operation panel 15 is an input device for inputting an event corresponding to a pressed button. The panel 15 includes a plurality of buttons for starting their respective functions. These buttons include a television (TV) start button switch (second switch) 15A.

The TV start button switch 15A enables the computer 10 to execute an audio/video (AV) function for, for example, viewing TV broadcast program data. When a user presses the TV start button switch 15A, the main body 11 is turned on. At this time, a sub-operating system (sub-OS) 132 (FIG. 2), described later, is booted. Upon booting the sub-OS 132, a TV application (TV application program) is automatically executed. Thus, the AV function is executed.

The main body 11 has a TV antenna connector 18 on its right side. A TV antenna cable is connected to the TV antenna connector 18.

FIG. 2 is a block diagram illustrating the system configuration of the personal computer 10. As shown, the computer 10 comprises a CPU 111, north bridge 112, main memory 113, graphics controller 114, south bridge 115 and LCD 17. The computer 10 further comprises a BIOS-ROM 120, hard disk drive (HDD) 130, local area network (LAN) controller 141, card controller 142, TV tuner (TV tuner/capture unit) 143, universal serial bus (USB) ports 151 and 152, selectable bay device 160, embedded-controller/keyboard-controller IC (EC/KBC) 170, and power supply circuit 180.

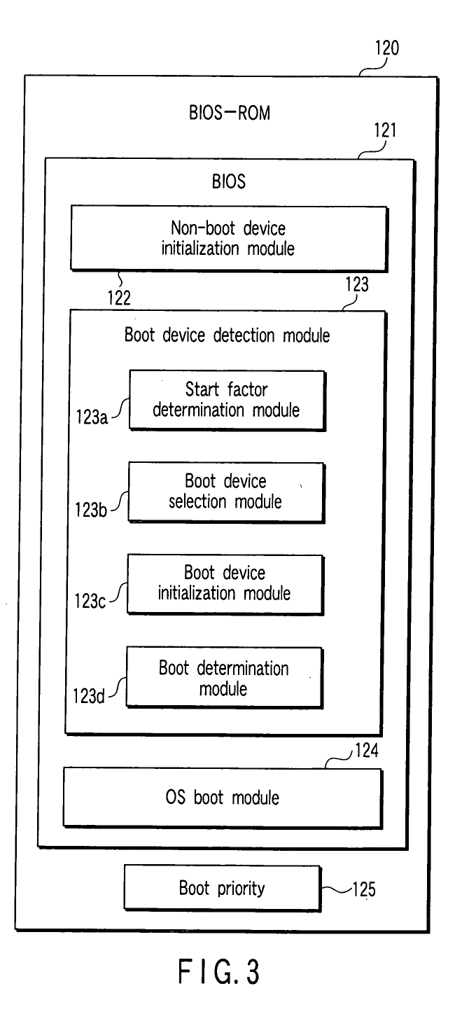

The CPU 111 is a processor for controlling the operation of the computer 10. The CPU 111 executes a main-operating system/sub-operating system loaded from a boot device to the main memory 113. The CPU 111 also executes various application programs and a basic input output system (BIOS) 121 (see FIG. 3) stored in the BIOS-ROM 120. The BIOS 121 is a program for controlling hardware. When the CPU 111 executes the BIOS 121, hardware control is realized. For the sake of brevity, hereinafter, assume that the BIOS 121 controls hardware.

The north bridge 112 is a bridge device that connects a local bus of the CPU 111 and the south bridge 115. The north bridge 112 incorporates a memory controller for controlling access to the main memory 113. The north bridge 112 has a function of communicating with the graphics controller 114 via an accelerated graphics port (AGP) bus and the like.

The graphics controller 114 serves as a display controller and controls the LCD 17 used as a display monitor of the computer 10. The graphics controller 114 is a display controller and controls the LCD 17 used as the display monitor of the computer 10. The graphics controller 114 includes a video memory (VRAM) 114a, and generates, based on display data written to the VRAM 114a, a video signal indicating a display image to be displayed on the LCD 17.

The south bridge 115 has a function for controlling accesses to the BIOS-ROM 120. The south bridge 115 contains an integrated drive electronics (IDE) controller for controlling the HDD 130 and selectable bay device 160. The south bridge 115 is connected to a peripheral component interconnect (PCI) bus 2 and low pin count (LPC) bus 3, and controls the devices on the PCI bus 2 and LPC bus 3. Further, the south bridge 115 contains a USB controller 150.

The USB controller 150 controls USB devices connected to the UBS ports 151 and 152. For instance, USB memories or flexible disk drives (FDD) can be used as USB devices. An operating system (OS) may be stored in a USB device, such as a USB memory or FDD, and loaded from the USB device to the main memory 113 via the USB controller 150, thereby starting up the computer 10. Thus, the USB controller 150 is treated as a boot device. Note that FIG. 2 does not show USB ports other than the USB ports 151 and 152.

The BIOS-ROM 120 is a rewritable nonvolatile memory such as a flash ROM. FIG. 3 shows the essential part of the BIOS 121 stored in the BIOS-ROM 120. The BIOS 121 includes a plurality of program modules necessary to execute a power on self test (POST) process for starting up (booting) the computer 10 (OS). In this embodiment, the BIOS 121 includes a non-boot device initialization module 122, boot device detection module 123 and OS boot module 124.

The POST process is executed upon power-on of the main body 11. During the execution of the POST process, start processes including device diagnosis are executed. When either the power button switch 14 or the TV start button switch 15A is operated, the main body 11 is turned on. The non-boot device initialization module 122 and boot device detection module 123 are executed at the beginning of the POST process.

The non-boot device initialization module 122 is used to initialize the non-boot devices necessary to boot the OS. In the embodiment, the non-boot devices necessary to boot the OS are both chip sets, i.e., the north bridge 112 and south bridge 115, devices including the main memory 113, graphics controller 114 and FC/KBC 17, and buses necessary for the CPU 111 to access the devices. Specifically, the buses include the PCI bys 2, LPC bus 3, a bus connecting the CPU 111 and north bridge 112, a bus connecting the north bridge 112 and graphics controller 114, and a bus connecting the north bridge 112 and south bridge 115.

The boot device detection module 123 is used to execute a boot device detection process for detecting and then initializing only a minimum number of boot devices necessary for OS booting. The boot device detection module 123 includes a start factor determination module 123a, boot device selection module 123b, boot device initialization module 123c and boot determination module 123d.

The start factor determination module 123a is used to determine the factor that needs OS booting. The boot device selection module 123b is used to select a minimum number of boot devices necessary for OS booting. This selection is made based on the priority of booting that is indicated by boot priority information. The boot priority information is stored in a boot priority storing area 125 secured in the BIOS-ROM 120. Namely, the boot priority storing area 125 is used as a memory unit for storing the boot priority information. The memory unit may be formed of a nonvolatile memory provided independently of the BIOS-ROM 120.

The boot device initialization module 123c is used to initialize the selected boot devices. The boot determination module 123d is used to determine whether the initialized boot devices can boot the OS. If the boot determination module 123d determines that the boot devices can boot the OS, the OS boot module 124 boots the OS using the boot devices determined to be able to boot the OS.

Referring again to FIG. 2, the HDD 130 is a storing device for storing various types of software and data. The HDD 130 prestores a main operating system (main OS) 131 and a sub-operating system (sub-OS) 132. Namely, the HDD 130 is a boot device. The main operating system (main OS) 131 is a versatile OS. The sub-operating system (sub-OS) 132 is a particular OS having only minimum functions for processing audio/video (AV) data that includes TV broadcast program data. In other words, the functionality of the sub-OS 132 is limited to an AV process (particular process). The main OS 131 and sub-OS 132 are loaded into the main memory 113, and are executed by the CPU 111. TV applications are made to run on the sub-OS 132.

The PCI bus 2 is connected to the LAN controller 141 and card controller 142. The LAN controller 141 is a network controller (communication device) for connecting the computer 10 to a network. For example, when a server is connected to the LAN controller 141 via the network, an OS can be loaded from the server to the main memory 113 via the LAN controller 141. Accordingly, the LAN controller 141 is treated as a boot device. Although FIG. 2 shows no wireless LAN controller, this controller is also treated as a boot device.

The card controller 142 controls card devices, such as PC cards or secure digital (SD) cards, inserted in a card slot connected to the card controller 142. The OS can be stored in a card device and loaded therefrom to the main memory 113 via the card controller 142 to start up the computer 10. Thus, the card controller 142 can be used as a boot device.

The PCI bus 2 is also connected to the TV tuner 143. The TV tuner 143 is connected to the TV antenna connector 18 to demodulate, into video data and audio data, a TV broadcast signal input via the TV antenna connector 18. In the TV tuner 143, the demodulated video data is compressed and coded by a compression/encoding method, such as moving picture coding experts group 2 (MPEG2), and then output to the PCI bus 2. The compressed/encoded video data on the PCI bus 2 is decoded based on a TV application, and is then displayed on the LCD 17 by the graphics controller 114.

The selectable bay device 160 is a boot device formed of, for example, a connector 161 and optical disk drive (ODD) 162. The ODD 162 is a drive unit for driving optical storage media, such as digital versatile discs (DVD) and compact discs (CD). In addition to the HDD 130, the selectable bay device 160 can contain a second HDD, instead of the ODD 162.

The EC/KBC 170 is a single-chip microcomputer in which an embedded controller (EC) for managing power and a keyboard controller (KBC) for controlling the keyboard (KB) 13 and the touch pad 16 are integrated. The EC/KBC 170 has a function of cooperating with the power supply circuit 180 to power on and off the main body 11 in accordance with user's pressing of the power button switch 14 or TV start button switch 15A. The power supply circuit 180 generates a system power supply voltage to be applied to each component of the main body 11, using a battery 181, or an external power supply voltage applied via an AC adaptor 182.

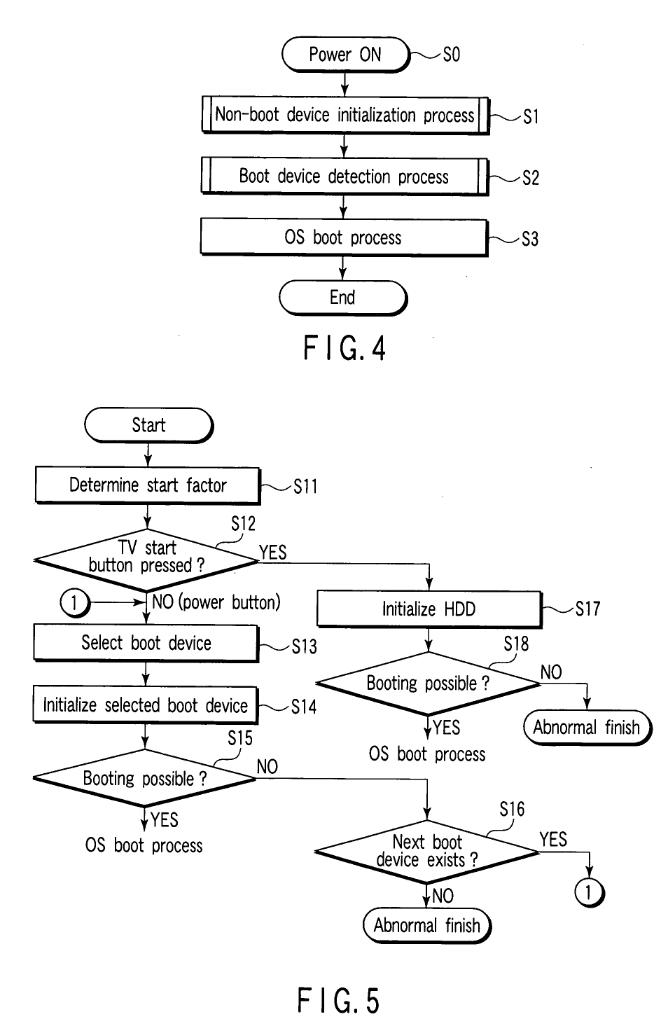

Referring then to the flowchart of FIG. 4, a description will be given of the procedure of a start process (POST process) performed by the BIOS 121 upon power on of the main body 11 (computer 10). The main body 11 is powered on when the user operates either the power button switch 14 or TV start button switch 15A incorporated in the main body 11.

Upon power on of the main body 11 (block S0), the BIOS 121 performs a start process called a POST process for starting up the computer 10 as follows:

Firstly, the non-boot device initialization module 122 of the BIOS 121 is started up, thereby executing a non-boot device initialization process for initializing the non-boot devices necessary for booting the OS (OS booting) (block S1). As a result, the north bridge 112, south bridge 115, main memory 113, graphics controller 114 and EC/KBC 17 are initialized. Further, the PCI bus 2, the LPC bus 3, the bus connecting the CPU 111 to the north bridge 112, the bus connecting the north bridge 112 to the graphics controller 114, and the bus connecting the north bride to the south bridge 115 are initialized.

Subsequently, the boot device detection module 123 of the BIOS 121 is started up, thereby executing a boot device detection process including a process for initializing only the a minimum number of boot devices necessary for OS booting (block S2).

Referring to the flowchart of FIG. 5, the procedure of the boot device detection process (block S2) will be described in detail. Firstly, the start factor determination module 123a included in the boot device detection module 123 determines the factor (start factor) that causes the start process to be started, i.e., the factor that causes the main body 11 to be powered on (block S11). If the pressing of the power button switch 14 is the start factor (block S12), the start factor determination module 123a transfers control to the boot device selection module 123b.

The boot device selection module 123b selects the to-be-initialized boot device, based on the boot priority information stored in the boot priority storing area 125 secured in the BIOS-ROM 120 (block S13). At the first block S13, a boot device of the highest priority is selected.

After the boot device selection module 123b selects the to-be-initialized boot device, the boot device initialization module 123c initializes the selected boot device (block S14). As a result, setting of a transmission rate, legacy processing, etc., are performed. At block S14, assignment of resources to the selected boot device, setting of interrupts, etc., are also performed. When the selected boot device is, for example, the LAN controller 141, an option ROM is called. In other words, when a boot device (non LAN boot device) other than the LAN controller 141 is selected, no option ROM is called, which reduces the time required for initialization.

After the selected boot device is initialized, the boot determination module 123d included in the boot device detection module 123 determines whether OS booting (i.e., the startup of the computer 10) from the selected boot device is possible (block S15). If the selected boot device is, for example, the card controller 142, and no card device, such as a PC card, is inserted in the card slot connected to the card controller 142, it is determined at block S15 that startup is impossible.

If it is determined at block S15 that startup is possible, the boot determination module 123d determines that the selected boot device is an OS-boot-enabled device. In this case, i.e., when an OS-boot-enabled device is detected, the boot determination module 123d interrupts selection of another boot device by the boot device selection module 123b. As a result, a series of boot device detection processes by the boot device detection module 123 is finished, and control is transferred to the OS boot module 124.

The OS boot module 124, in turn, executes an OS boot process for booting the OS from the boot device determined to be the OS-boot-enabled device by the boot determination module 123d (block S3 in FIG. 4). As a result of the OS boot process, the OS is loaded into the main memory 113 from the boot device determined to be the OS-boot-enabled device,.whereby the OS is booted to start up the computer 10.

In contrast, if it is determined at block S15 that OS booting is impossible, the boot determination module 123d informs the boot device selection module 123b of this to thereby request selection of the next boot device. The boot device selection module 123b, in turn, determines whether there is a to-be-selected (initialized) boot device of the next-highest priority (block S16).

If there is no such to-be-selected (initialized) boot device, i.e., if all boot devices indicated by the boot priority information are already selected (initialized), the boot device selection module 123b determines that the OS cannot be booted by any boot device. In this case, the boot device detection process by the boot device detection module 123 is finished and regarded as abnormal.

In contrast, if there are one or more boot devices to be selected, the boot device selection module 123b selects the boot device of the next-highest priority as a to-be-initialized boot device (block S13). The boot device initialization module 123c initializes the newly selected boot device (block S14).

The processes at blocks S13 and S14 are iterated until an OS-boot-enabled boot device is detected, or until it is determined that OS booting is impossible, concerning all boot devices indicated by the boot priority information. Accordingly, when a boot device other than the boot device of the lowest priority is determined to be an OS-boot-enabled boot device, the boot devices of the priority levels lower than the determined boot device are not yet initialized. Namely, in the embodiment, only a minimum number of boot devices necessary for OS booting are initialized.

Thus, in the embodiment, the time required for initialization performed upon power on of the apparatus can be reduced compared to the prior art. This enables the startup process time (POST process time) to be reduced to thereby boot the OS at high speed. The higher the boot priority of the boot device determined to be able to boot the OS, the greater the advantage. In the embodiment, the boot devices that are not initialized by the above startup process are initialized by the OS booted.

When the boot device of the lowest priority is determined to be an OS-boot-enabled one, this means that all boot devices are initialized by the startup process. Even in this case, the time required for initialization is substantially equal to and not longer than that required in the prior art. Moreover, it is very rare that such a state will occur.

Assume here that the factor (the factor of the power on of the main body 11) that causes the startup process to be started is the pressing of the TV start button switch 15A (block S12). In this case, the start factor determination module 123a transfers control to the boot device initialization module 123c. In the embodiment, the TV application for viewing TV broadcast program data runs on the sub-OS 132 prestored in the HDD 130.

Accordingly, when the boot device initialization module 123c is started up by the startup process performed upon the pressing of the TV start button switch 15A, it initializes the HDD 130 regardless of the priority indicated by the boot priority information (block S17).

After the boot device initialization module 123c initializes the HDD 130, the boot determination module 123d determines whether the HDD 130 can boot the sub-OS 132 (block S18). If it is determined at block S18 that sub-OS booting is possible, a series of boot device detection processes is normally finished. At this time, the OS boot module 124 executes an OS boot process for booting the sub-OS 132 from the HDD 130 (block S3 in FIG. 4).

As described above, in the embodiment, when the user presses the TV start button switch 15A to, for example, see a TV broadcast program, a boot device, such as the ODD 162, which is irrelevant to the viewing of the TV broadcast program, is not initialized. Accordingly, the time required for initialization performed when the apparatus is powered on by the pressing of the TV start button switch 15A can be reduced, thereby realizing a high-speed startup process. Namely, in the embodiment, when a certain OS is booted, a boot device unnecessary for the booting of the OS is prevented from being initialized. This eliminates, for example, the problem of extra power consumption by the unnecessary boot device.

In addition, the sub-OS 132 has minimum functionality for executing AV processes that include the processing of TV broadcast program data. Therefore, the time required for booting the sub-OS 132 is significantly shorter than that required for booting the versatile main OS 131. Thus, the user can quickly view a TV broadcast program simply by pressing the TV start button switch 15A.

While certain embodiments of the inventions have been described, these embodiments have been presented by way of example only, and are not intended to limit the scope of the inventions. Indeed, the novel apparatuses and methods described herein may be embodied in a variety of other forms; furthermore, various omissions, substitutions are changes in the form of the apparatuses and methods described herein may be made without departing from spirit of the inventions. The accompanying claims and their equivalents are intended to cover such forms or modifications as would fall within the scope and sprit of the inventions.

What is claimed is:

1. An information processing apparatus comprising:
a main body including a plurality of boot devices and a plurality of non-boot devices, the non-boot devices being necessary to boot an operating system;
means for initializing the non-boot devices upon power on of the main body;
means for detecting, in the boot devices, a boot device which satisfies a condition for booting the operating system, after initializing the non-boot devices, the detecting means including means for sequentially initializing the boot devices one by one until the boot device which satisfies the condition is detected; and
means for booting the operating system from the boot device detected by the detecting means.

2. The information processing apparatus according to claim 1, further comprising a storing unit which stores boot priority information indicating a priority of the boot devices, and wherein the sequentially initializing means initializes the boot devices one by one in the priority indicated by the boot priority information.

3. The information processing apparatus according to claim 2, wherein the detecting means includes:
means for selecting, from the boot devices, a boot device to be initialized by the sequentially initializing means, in the priority indicated by the boot priority information, after initializing the non-boot devices; and
means for determining whether the boot device initialized by the sequentially initializing means satisfies the condition, the determining means requesting the selecting means to select a boot device included in the boot devices and to be initialized next, when it is determined that the boot device initialized by the sequentially initializing means does not satisfy the condition

4. The information processing apparatus according to claim 3, further comprising:
a first switch incorporated in the main body;
a second switch incorporated in the main body; and
a controller which powers on the main body in accordance with an operation of one of the first and second switches,
and wherein:
the boot devices include a particular boot device which stores a particular operating system dedicated to a particular process and having limited functionality compared to a versatile operating system; and
when the main body is powered on in accordance with the operation of the first switch, each time the selecting means selects a boot device from the boot devices, the sequentially initializing means initializes the selected boot device, the sequentially initializing means initializing only the particular boot device when the main body is powered on in accordance with the operation of the second switch.

5. The information processing apparatus according to claim 4, wherein:
the detecting means includes factor determination means for determining a factor which causes the power on of the main body, the factor determination means determining the operation of which one of the first and second switches is the factor of the power on of the main body; and
the sequentially initializing means determines that the main body is powered on in accordance with the operation of the first switch, when it is determined that the factor of the power on is the operation of the first switch, and determines that the main body is powered on in accordance with the operation of the second switch, when it is determined that the factor of the power on is the operation of the second switch.

6. The information processing apparatus according to claim 4, wherein the particular operating system is configured to process TV broadcast program data.

7. A method of starting up an information processing apparatus including a plurality of boot devices and a plurality of non-boot devices, the non-boot devices being necessary to boot an operating system, the method comprising:
initializing the non-boot devices upon power on of the information processing apparatus;
selecting a to-be-initialized boot device from the boot devices after initializing the non-boot devices;
initializing the selected boot device;
determining whether the initialized boot device satisfies a condition for booting an operating system;
causing the selecting to select a boot device included in the boot devices and to be initialized next, when it is determined that the initialized boot device does not satisfy the condition; and
starting up the information processing apparatus by booting the operating system from the initialized boot device, when it is determined that the initialized boot device satisfies the condition.

8. The method according to claim 7, wherein the to-be-initialized boot device is selected in accordance with boot priority information indicating a priority of the boot devices, the boot priority information being stored in a storing unit incorporated in the information processing apparatus.

9. The method according to claim 8, further comprising powering on the information processing apparatus in accordance with an operation of one of a first switch and a second switch incorporated in the information processing apparatus,
and wherein:
when the information processing apparatus is powered on in-accordance with the operation of the first switch, the to-be-initialized boot device is selected in accordance with the boot priority information; and
when the information processing apparatus is powered on in accordance with the operation of the second switch, only a particular boot device included in the boot devices and storing a particular operating system is initialized regardless of the priority of the boot devices indicated by the boot priority information, the particular operating system being dedicated to a particular process and having limited functionality compared to a versatile operating system.

10. The method according to claim 9, further comprising determining the operation of which one of the first and second switches is a factor which causes the power on, after initializing the non-boot devices,
and wherein:
when it is determined that the factor of the power on is the operation of the first switch, it is determined that the information processing apparatus is powered on in accordance with the operation of the first switch, and the to-be-initialized boot device is selected in accordance with the boot priority information; and
when it is determined that the factor of the power on is the operation of the second switch, it is determined that the information processing apparatus is powered on in accordance with the operation of the second switch, and only the particular boot device storing the particular operating system is initialized.
